(19) United States
(12) Patent Application Publication
(10) Pub. No.: US 2026/0369904 A1
(43) Pub. Date: Nov. 19, 2026

(54) POWER INPUT TERMINAL BLOCK

(71) Applicant: TE Connectivity Solutions GmbH, Schaffhausen (CH)

(72) Inventors: Matthew Edward MOSTOLLER, Middletown, PA (US); Christopher George DAILY, Middletown, PA (US)

(21) Appl. No.: 19/209,873

(22) Filed: May 16, 2025

(51) Int. Cl. H01R 9/24

(52) U.S. Cl. CPC H01R 9/2416

(57) ABSTRACT

A power input terminal block includes a housing having terminals received in terminal channels each having a main body extending between a wire terminating end and a blade terminating end. The wire terminating end has a separable wire interface configured to be electrically connected to a supply wire. The blade terminating end has a separable blade interface configured to be electrically connected to a blade terminal. The power input terminal block includes clamp contacts received in the terminal channels each having a clamp beam being electrically connected to the corresponding supply wire. A poke-in window is defined between the clamp beam and the wire terminating end to capture the supply wire. The power input terminal block includes release elements operably coupled to the corresponding clamp contact to move the clamp beam between an extended position and a clamping position to allow loading and removal of the supply wire from the poke-in window.

### BACKGROUND OF THE INVENTION

The subject matter herein relates generally to power input terminal blocks.

Power input terminal blocks are used to distribute power in a system, such as a lighting system. For example, streetlights use power input terminal blocks to distribute power within the light fixture from the main supply wires to take-off wires used to power light fixture components, such as the driver, the light element, and the like. Other applications that use power input terminal blocks include appliances, HVAC devices, energy storage components, electric charging systems, and other types of power supply devices. Conventional power input terminal blocks use threaded terminal lugs with set screws to connect the line, ground and neutral wires. Separate male tab contacts extend from the threaded terminal lug. Female tab terminals are connected to the male tab contacts by pressing the female tab terminals onto the male tab contacts. The female tab terminals are crimped to ends of the take-off wires. The female tab terminals occupy space within the power input terminal block and add cost and complexity to the assembly process. The connections made between the components are time consuming to make and typically require tools to connect.

A need remains for a cost effective and reliable power input terminal block.

### BRIEF DESCRIPTION OF THE INVENTION

In one embodiment, a power input terminal block is provided and includes a housing that includes terminal channels with separating walls between the terminal channels. The power input terminal block includes terminals received in the terminal channels. Each terminal includes a main body extending between a wire terminating end and a blade terminating end. The wire terminating end has a separable wire interface configured to be electrically connected to a supply wire. The blade terminating end has a separable blade interface configured to be electrically connected to a blade terminal. The power input terminal block includes clamp contacts received in the terminal channels. Each clamp contact has a clamp beam configured to be electrically connected to the corresponding supply wire. A poke-in window is defined between the clamp beam and the wire terminating end of the terminal configured to receive the supply wire to capture the supply wire between the clamp beam and the wire terminating end. The power input terminal block includes release elements coupled to the housing. Each release element operably coupled to the corresponding clamp contact to move the clamp beam between an extended position and a clamping position to allow loading and removal of the supply wire from the poke-in window.

In another embodiment, a power input terminal block is provided and includes a housing that includes terminal channels with separating walls between the terminal channels. The housing includes poke-in wire openings configured to receive supply wires. The housing includes blade slots configured to receive ends of blade terminals. The power input terminal block includes terminals received in the terminal channels. Each terminal includes a main body extending between a wire terminating end and a blade terminating end. The wire terminating end is aligned with the corresponding poke-in wire opening and has a separable wire interface configured to be electrically connected to the supply wire received in the poke-in wire opening. The blade terminating end is aligned with the blade slot and has a separable blade interface configured to be electrically connected to the blade terminal received in the blade slot. The power input terminal block includes clamp contacts received in the terminal channels. Each clamp contact has a clamp beam aligned with the poke-in wire opening configured to be electrically connected to the corresponding supply wire received in the poke-in wire opening. A poke-in window is defined between the clamp beam and the wire terminating end of the terminal configured to receive the supply wire to capture the supply wire between the clamp beam and the wire terminating end. The power input terminal block includes release elements coupled to the housing. Each release element operably coupled to the corresponding clamp contact to move the clamp beam between an extended position and a clamping position to allow loading and removal of the supply wire from the poke-in window.

In a further embodiment, a power input terminal block is provided and includes a housing that includes terminal channels with separating walls between the terminal channels. The housing includes a mounting end configured to be mounted to a fixture. The power input terminal block includes terminals received in the terminal channels. Each terminal includes a main body extending between a wire terminating end and a blade terminating end. The wire terminating end has a separable wire interface configured to be electrically connected to a supply wire. The blade terminating end has a separable blade interface configured to be electrically connected to a blade terminal. The power input terminal block includes clamp contacts received in the terminal channels. Each clamp contact has a clamp beam configured to be electrically connected to the corresponding supply wire. A poke-in window is defined between the clamp beam and the wire terminating end of the terminal configured to receive the supply wire to capture the supply wire between the clamp beam and the wire terminating end. The power input terminal block includes release elements coupled to the housing. Each release element operably coupled to the corresponding clamp contact to move the clamp beam between an extended position and a clamping position to allow loading and removal of the supply wire from the poke-in window. The power input terminal block includes a ground strap coupled to the housing. The ground strap includes a connecting end configured to be electrically connected to a grounded portion of the fixture to electrically ground the ground strap.

### BRIEF DESCRIPTION OF THE DRAWINGS

FIG. 1 illustrates an electrical device having a power input terminal block in accordance with an exemplary embodiment.

FIG. 2 illustrates a streetlight having the power input terminal block in accordance with an exemplary embodiment.

FIG. 3 is a top perspective view of the power input terminal block in accordance with an exemplary embodiment.

FIG. 4 is a bottom perspective view of the power input terminal block in accordance with an exemplary embodiment.

FIG. 5 shows the power input terminal block poised for coupling to the electrical device in accordance with an exemplary embodiment.

FIG. 6 is a cross-sectional view of the power input terminal block coupled to the electrical device in accordance with an exemplary embodiment.

FIG. 7 shows the power input terminal block poised for coupling to the electrical device in accordance with an exemplary embodiment.

FIG. 8 is a top perspective view of the power input terminal block in accordance with an exemplary embodiment.

FIG. 9 is a bottom perspective view of the power input terminal block in accordance with an exemplary embodiment.

FIG. 10 shows the power input terminal block poised for coupling to the electrical device in accordance with an exemplary embodiment.

FIG. 11 is a cross-sectional view of the power input terminal block coupled to the electrical device in accordance with an exemplary embodiment.

FIG. 12 is a front perspective view of the power input terminal block in accordance with an exemplary embodiment.

FIG. 13 is a rear perspective view of the power input terminal block in accordance with an exemplary embodiment.

FIG. 14 is a cross-sectional view of the power input terminal block coupled to the electrical device showing the release elements in a released or unactuated position in accordance with an exemplary embodiment.

FIG. 15 is a cross-sectional view of the power input terminal block coupled to the electrical device showing the release elements in an actuated position in accordance with an exemplary embodiment.

FIG. 16 is a top perspective view of the power input terminal block in accordance with an exemplary embodiment.

FIG. 17 is a bottom perspective view of the power input terminal block in accordance with an exemplary embodiment.

FIG. 18 is a cross-sectional view of the power input terminal block coupled to the electrical device in accordance with an exemplary embodiment.

### DETAILED DESCRIPTION OF THE INVENTION

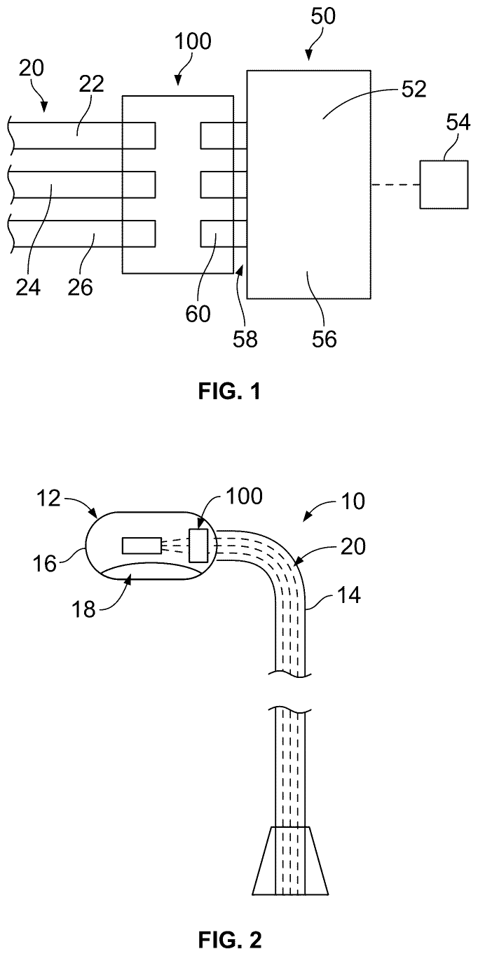

FIG. 1 illustrates an electrical device 50 having a power input terminal block 100 in accordance with an exemplary embodiment. The power input terminal block 100 supplies power to the electrical device 50. In an exemplary embodiment, supply wires 20 are used to supply electrical power to the electrical device 50 for operating the electrical device 50. The supply wires 20 are coupled to the power input terminal block 100 at separable mating interfaces, such as poke-in wire terminations, to allow connection and removal of the supply wires 20 to the power input terminal block 100. The supply wires 20 may include a power wire 22 a ground wire 24 and a neutral wire 26.

The electrical device 50 includes a power connector 52 for powering one or more components 54 of the electrical device 50. The power connector 52 includes a fixture 56 having a mounting area 58. The power input terminal block 100 is coupled to the fixture 56 at the mounting area 58. In an exemplary embodiment, the power connector 52 includes one or more power terminals 60 held by the fixture 56. The power terminals 60 are configured to be electrically connected to the power input terminal block 100. In an exemplary embodiment, the power terminals 60 have separable mating interfaces to allow the power input terminal block 100 to mate to and unmate from the power terminals 60 and the electrical device 50. In an exemplary embodiment, the power terminals 60 are blade terminals and may be referred to hereinafter as blade terminals 60. The blade terminals 60 have planar tabs or blades having opposite first and second planar sides. The power terminals 60 may be other types of contacts or terminals in alternative embodiments.

The electrical device 50 may be a lighting device, such as a streetlight. The power input terminal block 100 may be used in other applications other than the streetlight in alternative embodiments. For example, the power input terminal block 100 may be used in a building power system, in an industrial power system, in a vehicle power system, in an appliance, in an HVAC system, in an energy storage device, in a power charging system, and the like.

FIG. 2 illustrates a streetlight 10 having the power input terminal block 100 in accordance with an exemplary embodiment. The streetlight 10 includes a light fixture 12 mounted to a pole 14. The light fixture 12 includes a fixture housing 16 and a light assembly 18 within the fixture housing 16. The supply wires 20 are used to supply electrical power to the light assembly 18 for operating the lighting assembly 18. The supply wires 20 pass through the interior of the pole 14 to the power input terminal block 100. The supply wires 20 supply electrical power to the light assembly 18, such as for powering a light, a driver assembly, and the like of the light assembly 18. In the illustrated embodiment, the power input terminal block 100 is provided in the light fixture 12. However, the power input terminal block 100 may be provided in the pole 14, such as at the top or at the bottom in alternative embodiments.

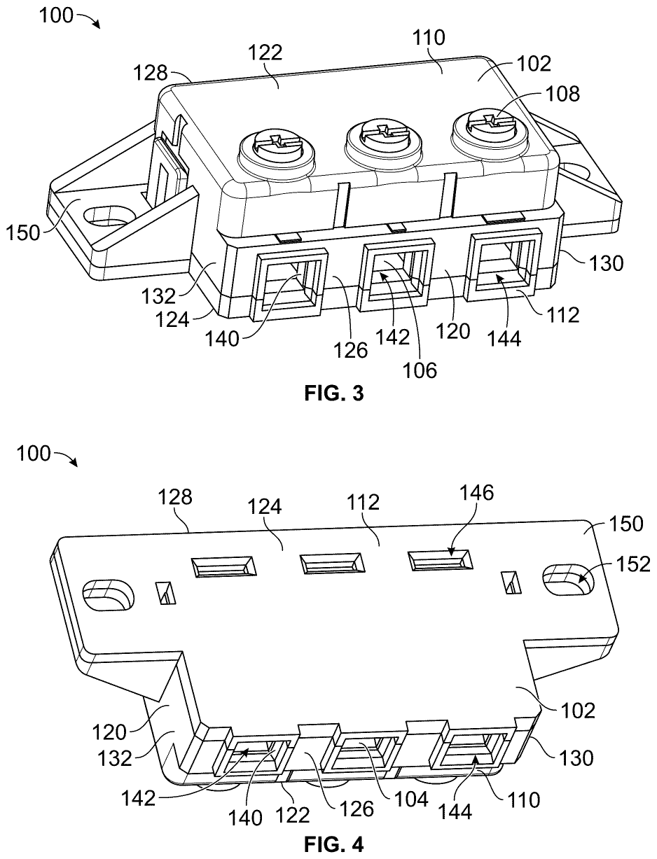

FIG. 3 is a top perspective view of the power input terminal block 100 in accordance with an exemplary embodiment. FIG. 4 is a bottom perspective view of the power input terminal block 100 in accordance with an exemplary embodiment. The power input terminal block 100 includes a housing 102, terminals 104, clamp contacts 106, and release elements 108.

In an exemplary embodiment, the power input terminal block 100 is configured to receive the supply wires 20 (shown in FIG. 1) and is configured to receive the blade terminals 60 (shown in FIG. 1) used to power other components within the electrical device 50 (shown in FIG. 1). In an exemplary embodiment, the supply wires 20 and the blade terminals 60 are configured to be poked or plugged into the power input terminal block 100 for quick assembly and electrical connection. The supply wires 20 and the blade terminals 60 are separable from the power input terminal block 100, such as for rewiring, repair, or replacement. The supply wires 20 and the blade terminals 60 may be quickly and easily connected to the power input terminal block 100. The supply wires 20 and the blade terminals 60 may be connected to the power input terminal block 100 without the use of tools. In an exemplary embodiment, the release elements 108 are used to release the clamp contacts 106 to allow insertion and removal of the supply wires 20 without damaging the supply wires 20 or other components of the power input terminal block 100. In the illustrated embodiment, the supply wires 20 and the blade terminals 60 are loaded through openings in the housing 102 for termination to the clamp contacts 106 and the terminals 104.

In an exemplary embodiment, the housing 102 is a multi-piece housing including a cover 110 configured to be coupled to a housing base 112. The housing 102 may include other pieces in alternative embodiments. The housing 102 includes a plurality of walls 120 defining the housing 102. The housing 102 extends between a top 122 and a bottom 124. The housing 102 includes a front 126 and the rear 128. The housing 102 includes a first side 130 and a second side 132 opposite the first side 130. The walls 120 may include a top wall, a bottom wall, a front wall, a rear wall, a first side wall, a second side wall, or other walls.

In an exemplary embodiment, the housing 102 includes separating walls 140 separating terminal channels 142 from each other. The terminal channels 142 receive the corresponding terminals 104 and clamp contacts 106. The terminal channels 142 may be open at the front 126 to receive the supply wires 20 and may be open at the rear 128 or the bottom 124 to receive the blade terminals 60. In an exemplary embodiment, the cover 110 is coupled to the housing base 112 at the top 122 of the housing 102 to close the terminal channels 142 and retain the terminals 104 in the terminal channels 142.

In an exemplary embodiment, the housing 102 includes wire openings 144 at the front 126 that receive corresponding supply wires 20. The supply wires 20 may be loaded through the wire openings 144 into the terminal channels 142. The supply wires 20 may be mechanically and electrically connected to the terminals 104 and clamp contacts 106 in the terminal channels 142.

In an exemplary embodiment, the housing 102 includes blade slots 146 that receive corresponding blade terminals 60. In the illustrated embodiment, the blade slots 146 are located at the bottom 124, such as proximate to the rear 128. Other locations are possible in alternative embodiments, such as at the rear 128. The blade terminals 60 may be loaded through the blade slots 146 into the terminal channels 142. The blade terminals 60 may be mechanically and electrically connected to the terminals 104 in the terminal channels 142.

In an exemplary embodiment, the housing 102 includes mounting tabs 150 used for mounting the power input terminal block 100 to a structure, such as the fixture 56 (shown in FIG. 1). In the illustrated embodiment, the mounting tabs 150 are provided at the first side 130 and the second side 132. Other positions are possible in alternative embodiments, such as the bottom 124, the front 126 and/or the rear 128. Each mounting tab 150 includes an opening 152 configured to receive a fastener (not shown), such as a threaded fastener. The mounting tabs 150 may be secured to the mounting structure by other means in alternative embodiments.

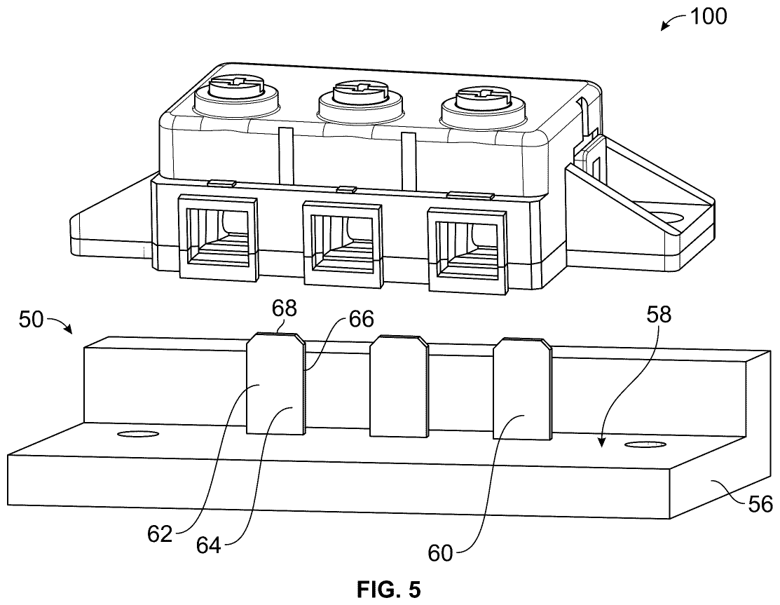

FIG. 5 shows the power input terminal block 100 poised for coupling to the electrical device 50 in accordance with an exemplary embodiment. FIG. 5 shows the power input terminal block 100 configured to be coupled to the fixture 56 at the mounting area 58 to mated with the blade terminals 60. In the illustrated embodiment the blade terminals 60 extend upward from a bottom wall of the fixture 56. The power input terminal block 100 is mated to the blade terminals 60 in a downward mating direction.

In an exemplary embodiment, the blade terminals 60 include tabs or blades 62. The blade 62 is planar having a first side 64 and a second side 66 extending to an outer edge 68. The first and second sides 64, 66 are planar. The first and second sides 64, 66 define mating interfaces. In the illustrated embodiment, the electrical device 50 includes three of the blade terminals 60. For example, the blade terminals 60 may include a positive blade terminal, a negative blade terminal, and a neutral blade terminal. The blade terminals 60 may include a power or hot blade terminal, a ground blade terminal, and a neutral blade terminal. The electrical device 50 may include greater or fewer blade terminals 60 in alternative embodiments.

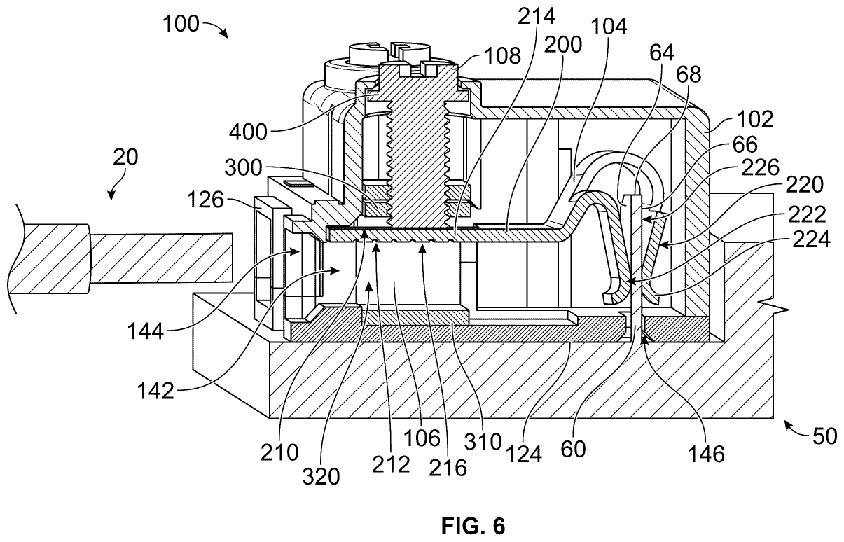

FIG. 6 is a cross-sectional view of the power input terminal block 100 coupled to the electrical device 50 in accordance with an exemplary embodiment. The power input terminal block 100 includes the housing 102, the terminals 104, the clamp contacts 106, and the release elements 108. Each terminal 104 is configured to be coupled to the corresponding blade terminal 60. Each terminal 104 is configured to be coupled to the corresponding supply wire 20. In an exemplary embodiment, the supply wires 20 and the blade terminals 60 are configured to be poked or plugged into the power input terminal block 100 for quick assembly and electrical connection. In an exemplary embodiment, the release elements 108 are used to release the clamp contacts 106 to allow insertion and removal of the supply wires 20 without damaging the supply wires 20 or other components of the power input terminal block 100.

The housing 102 includes the terminal channels 142 holding the terminals 104 and the clamp contacts 106. The housing 102 includes the wire openings 144 at the front 126 configured to receive the supply wires 20. The wire openings 144 may have lead-in surfaces to guide the supply wires 20 into the wire openings 144. The supply wires 20 may be loaded through the wire openings 144 into the terminal channels 142. The housing 102 includes the blade slots 146 at the bottom 124 configured to receive the blade terminals 60. The blade slots 146 may have lead-in surfaces to guide the blade terminals 60 into the blade slots 146. The blade terminals 60 may be loaded through the blade slots 146 into the terminal channels 142.

In an exemplary embodiment, the terminals 104 are metal terminals, such as being copper, copper alloy, aluminum, aluminum alloy, or other metal. The terminals 104 may be stamped and formed. Each terminal 104 includes a main body 200 extending between a wire terminating end 210 and a blade terminating end 220 at opposite ends of the terminal 104. The wire terminating end 210 has a separable wire interface 212 configured to be electrically connected to the supply wire 20. In an exemplary embodiment, the terminal 104 includes a plate 214 at the wire terminating end 210 having a mating pad 216 defining the separable wire interface 212. The plate 214 may be planar. The clamp contact 106 is configured to capture the supply wire 20 between the clamp contact 106 and the mating pad 216 to electrically connect the supply wire 20 to the terminal 104. The wire terminating end 210 may have other shapes or include other parts in alternative embodiments.

In an exemplary embodiment, the blade terminating end 220 includes a separable blade interface 222 configured to be electrically connected to the blade terminal 60. In an exemplary embodiment, the terminal 104 includes one or more spring beams 224 at the blade terminating end 220 configured be coupled to the blade terminal 60. For example, the terminal 104 includes a pair of the spring beams 224 at the blade terminating end 220. The spring beams 224 define a receptacle 226 configured to receive the outer edge 68 of the blade terminal 60 to engage the opposite sides 64, 66 of the blade terminal 60. Other types of mating interfaces may be provided in alternative embodiments, such as sockets, pins, bolt connections, weld connections, solder connections, and the like.

In an exemplary embodiment, the clamp contacts 106 are metal contacts, such as being copper, copper alloy, aluminum, aluminum alloy, or other metal. The clamp contacts 106 may be stamped and formed. Each clamp contact 106 includes a contact base 300 and a clamp beam 310 extending from the contact base 300. In an exemplary embodiment, the contact base 300 is coupled to the release element 108. The release element 108 may be actuated or moved to move the contact base 300. In alternative embodiments, the clamp beam 310 is coupled to the release element 108 and the release element 108 may be actuated or moved to move the clamp beam 310.

In an exemplary embodiment, the clamp beam 310 is configured to be electrically connected to the corresponding supply wire 20. In an exemplary embodiment, the clamp contact 106 is a rising cage type of clamp contact configured to move relative to the terminal 104 to capture the supply wire 20 therebetween. Other types of clamp contacts 106 may be provided in alternative embodiments, such as a spring beam style contact. The clamp beam 310 is movable relative to the housing 102, such as between an extended or released position and a contracted or clamping position. The clamp beam 310 is movable in the terminal channel 142. In an exemplary embodiment, a poke-in window 320 is defined between the clamp beam 310 and the wire terminating end 210 of the terminal 104 configured to receive the supply wire 20 to capture the supply wire 20 between the clamp beam 310 and the wire terminating end 210. In an exemplary embodiment, the clamp contact 106 is movable in the terminal channel 142 to open and close the poke in window 320. In various embodiments, the clamp contact 106 is slidable in a linear direction in the terminal channel 142. In other various embodiments, the clamp contact 106 is rotatable in the terminal channel 142.

The release elements 108 are coupled to the housing 102. Each release element 108 is operably coupled to the corresponding clamp contact 106 to move the clamp contact 106 between the extended position and the clamping position to allow loading and removal of the supply wire 20 from the poke-in window 320. In the illustrated embodiment, the release element 108 includes a threaded element 400 threadably coupled to the clamp contact 106 to move the clamp contact 106. For example, the threaded element 400 may be threadably coupled to the contact base 300. Rotation of the threaded element 400 causes movement of the contact base 300, and thus the clamp beam 310. For example, the clamp contact 106 may be raised and lowered in the terminal channel 142 in a vertical actuation direction. The clamp beam 310 is positioned in the terminal channel 142 spaced apart from the wire terminating end 210. The release element 108 is actuated (for example, rotated) to change the spacing between the clamp beam 310 and the wire terminating end 210. For example, the clamp beam 310 may be driven upward toward the wire terminating end 210 to close the height of the poke-in window 320 to capture the supply wire 20 therein. The supply wire 20 may be compressed between the clamp beam 310 and the mating pad 216 at the wire terminating end 210 to mechanically retain the supply wire 20 in the power input terminal block 100 and create a reliable electrical connection between the supply wire 20 and the terminal 104.

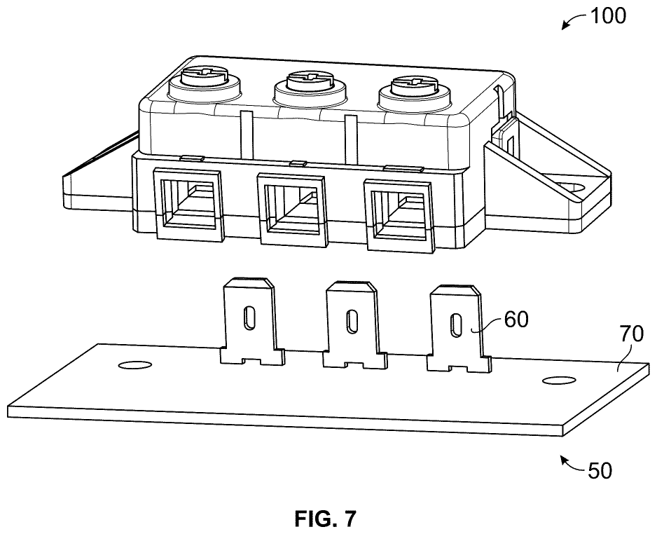

FIG. 7 shows the power input terminal block 100 poised for coupling to the electrical device 50 in accordance with an exemplary embodiment. FIG. 7 shows the power input terminal block 100 configured to be coupled to the fixture 56 at the mounting area 58 to mated with the blade terminals 60. In the illustrated embodiment the fixture 56 includes a circuit board 70 and the blade terminals 60 are mounted to the circuit board 70. The blade terminals 60 may be soldered, welded, or press fit to the circuit board 70 and extend upward from an upper surface of the circuit board 70. The power input terminal block 100 is mated to the blade terminals 60 in a downward mating direction.

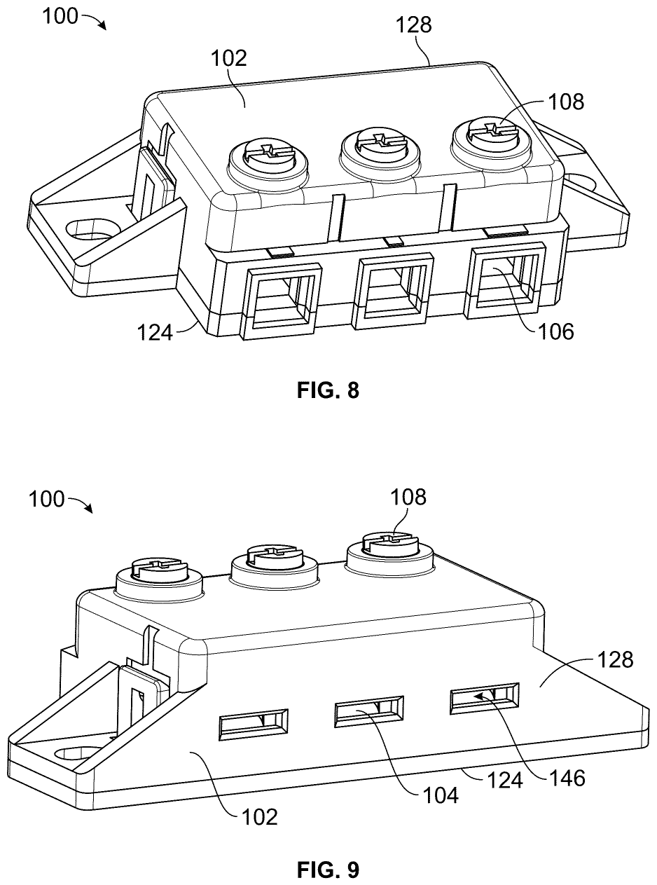

FIG. 8 is a top perspective view of the power input terminal block 100 in accordance with an exemplary embodiment. FIG. 9 is a bottom perspective view of the power input terminal block 100 in accordance with an exemplary embodiment. The power input terminal block 100 includes the housing 102, terminals 104, clamp contacts 106, and release elements 108. In the illustrated embodiment, the blade slots 146 are located at the rear 128 of the housing 102 rather than the bottom 124.

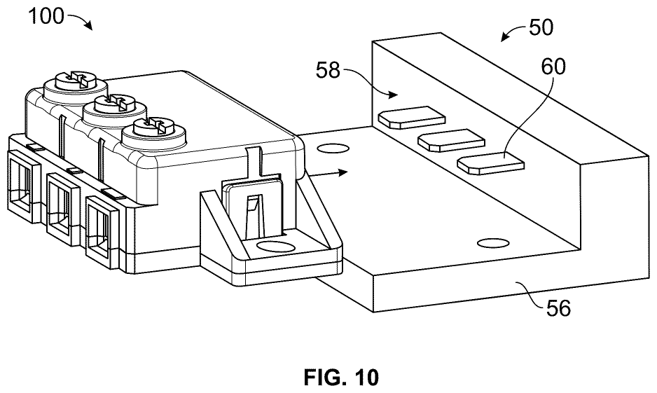

FIG. 10 shows the power input terminal block 100 poised for coupling to the electrical device 50 in accordance with an exemplary embodiment. FIG. 10 shows the power input terminal block 100 configured to be coupled to the fixture 56 at the mounting area 58 to mated with the blade terminals 60. In the illustrated embodiment the blade terminals 60 extend forward from a rear wall of the fixture 56. The power input terminal block 100 is mated to the blade terminals 60 in a horizontal mating direction.

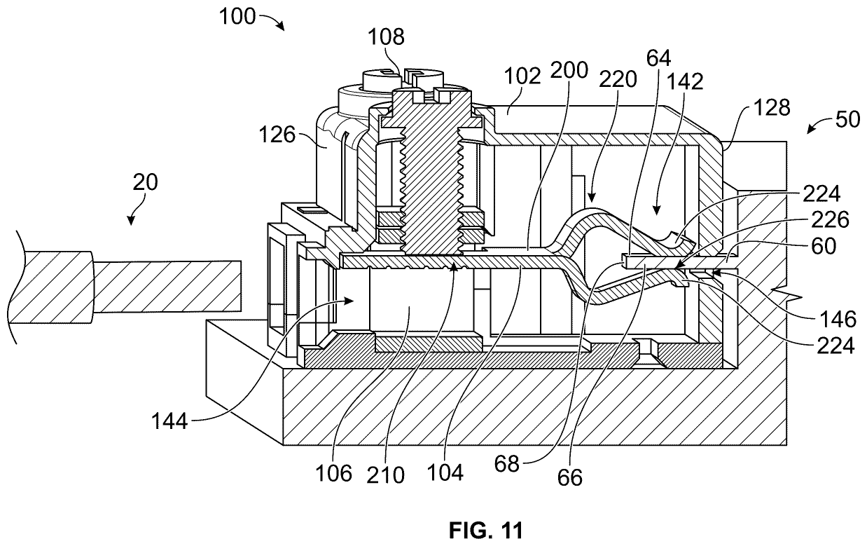

FIG. 11 is a cross-sectional view of the power input terminal block 100 coupled to the electrical device 50 in accordance with an exemplary embodiment. The power input terminal block 100 includes the housing 102, the terminals 104, the clamp contacts 106, and the release elements 108. Each terminal 104 is configured to be coupled to the corresponding blade terminal 60. Each terminal 104 is configured to be coupled to the corresponding supply wire 20. In an exemplary embodiment, the supply wires 20 and the blade terminals 60 are configured to be poked or plugged into the power input terminal block 100 for quick assembly and electrical connection. In an exemplary embodiment, the release elements 108 are used to release the clamp contacts 106 to allow insertion and removal of the supply wires 20 without damaging the supply wires 20 or other components of the power input terminal block 100.

The housing 102 includes the terminal channels 142 holding the terminals 104 and the clamp contacts 106. The housing 102 includes the wire openings 144 at the front 126 configured to receive the supply wires 20. The wire openings 144 may have lead-in surfaces to guide the supply wires 20 into the wire openings 144. The supply wires 20 may be loaded through the wire openings 144 into the terminal channels 142. The housing 102 includes the blade slots 146 at the rear 128 configured to receive the blade terminals 60. The blade slots 146 may have lead-in surfaces to guide the blade terminals 60 into the blade slots 146. The blade terminals 60 may be loaded through the blade slots 146 into the terminal channels 142.

In an exemplary embodiment, each terminal 104 includes the main body 200 extending between the wire terminating end 210 and the blade terminating end 220 at opposite ends of the terminal 104. The terminal 104 includes the spring beams 224 at the blade terminating end 220 defining the receptacle 226 configured to receive the outer edge 68 of the blade terminal 60 to engage the opposite sides 64, 66 of the blade terminal 60. Other types of mating interfaces may be provided in alternative embodiments, such as sockets, pins, bolt connections, weld connections, solder connections, and the like.

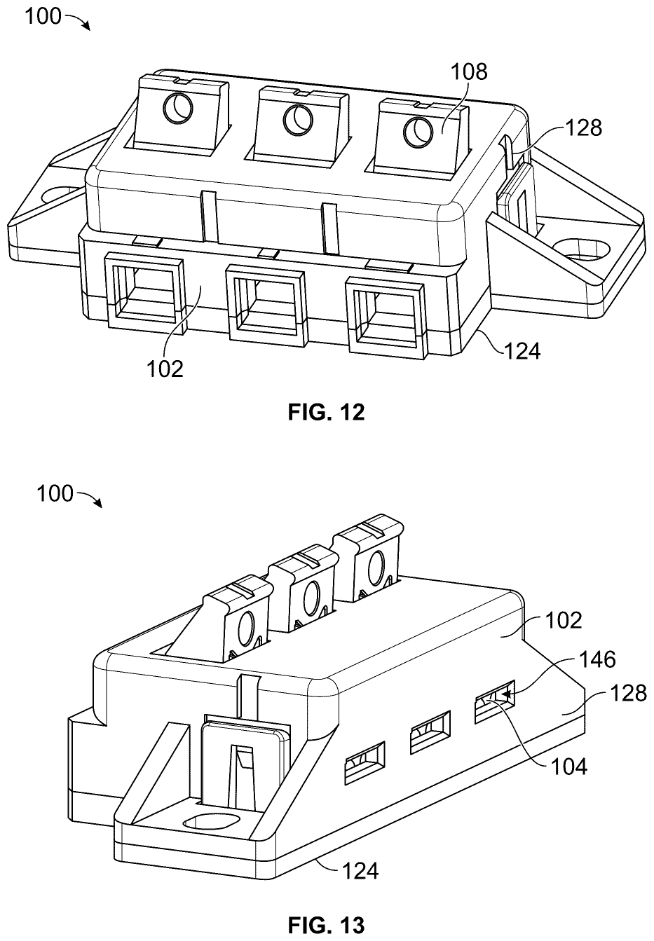

FIG. 12 is a front perspective view of the power input terminal block 100 in accordance with an exemplary embodiment. FIG. 13 is a rear perspective view of the power input terminal block 100 in accordance with an exemplary embodiment. The power input terminal block 100 includes the housing 102, terminals 104, clamp contacts 106, and release elements 108. In the illustrated embodiment, the blade slots 146 are located at the rear 128 of the housing 102 rather than the bottom 124. In the illustrated embodiment, the release elements 108 are rotatable release levers configured to be rotated to release the clamp contacts 106.

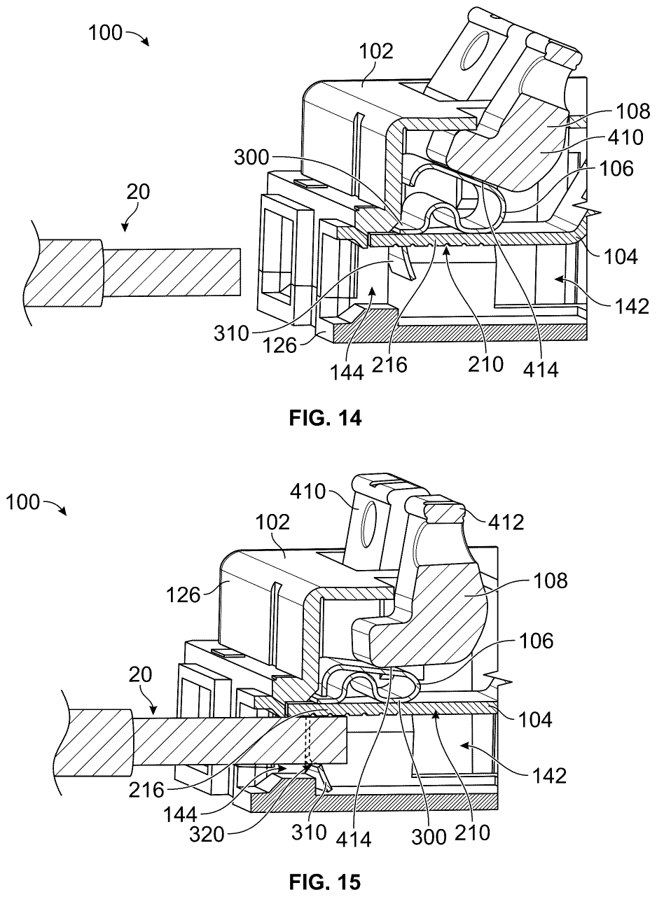

FIG. 14 is a cross-sectional view of the power input terminal block 100 coupled to the electrical device 50 showing the release elements 108 in a released or unactuated position. FIG. 15 is a cross-sectional view of the power input terminal block 100 coupled to the electrical device 50 showing the release elements 108 in an actuated position. The power input terminal block 100 includes the housing 102, the terminals 104, the clamp contacts 106, and the release elements 108.

Each terminal 104 is configured to be coupled to the corresponding blade terminal 60. Each terminal 104 is configured to be coupled to the corresponding supply wire 20. In an exemplary embodiment, the supply wires 20 and the blade terminals 60 are configured to be poked or plugged into the power input terminal block 100 for quick assembly and electrical connection. In an exemplary embodiment, the release elements 108 are used to release the clamp contacts 106 to allow insertion and removal of the supply wires 20 without damaging the supply wires 20 or other components of the power input terminal block 100.

The housing 102 includes the terminal channels 142 holding the terminals 104 and the clamp contacts 106. The housing 102 includes the wire openings 144 at the front 126 configured to receive the supply wires 20. The wire openings 144 may have lead-in surfaces to guide the supply wires 20 into the wire openings 144. The supply wires 20 may be loaded through the wire openings 144 into the terminal channels 142.

In an exemplary embodiment, the clamp contacts 106 are stamped and formed metal contacts. Each clamp contact 106 includes the contact base 300 and the clamp beam 310 extending from the contact base 300. In the illustrated embodiment, the contact base 300 is mounted to the terminal 104. For example, the contact base 300 may be welded to the terminal 104. The clamp beam 310 extends from the contact base 300 and may be deflectable relative to the contact base 300.

In an exemplary embodiment, the release element 108 is configured to be coupled to the clamp beam 310 to actuate or move the clamp beam 310. The release element 108 may be actuated or moved (for example, rotated) to move the clamp beam 310 relative to the contact base 300, such as to move the clamp beam 310 from a closed or clamping position (FIG. 14) to an open or extended position (FIG. 15). In an exemplary embodiment, the poke-in window 320 defined between the clamp beam 310 and the wire terminating end 210 of the terminal 104 is configured to be opened and closed by actuating the release element 108 and moving the clamp beam 310.

In an exemplary embodiment, the release elements 108 include release levers 410. The release levers 410 are configured to be coupled to the housing 102. For example, the release levers 410 may include pivot pins or other connecting elements configured to be coupled to the housing 102. The release lever 410 includes an actuator or handle 412 configured to be pressed or otherwise moved to pivot the release lever 410. The release lever 410 includes a releasing surface 414 operably coupled to the clamp contact 106 to move the clamp beam 310. For example, the release lever 410 may directly engage the clamp beam 310 to compress or move the clamp beam 310 relative to the contact base 300 and open the poke-in window 320. The clamp beam 310 is positioned in the terminal channel 142 and configured to be spaced apart from the wire terminating end 210 to open the poke-in window 320. The release element 108 is actuated (for example, pivoted) to change the spacing between the clamp beam 310 and the wire terminating end 210. When released, clamp beam 310 may be closed to capture the supply wire 20 in the poke-in window 320. The supply wire 20 may be compressed between the clamp beam 310 and the mating pad 216 at the wire terminating end 210 to mechanically retain the supply wire 20 in the power input terminal block 100 and create a reliable electrical connection between the supply wire 20 and the terminal 104.

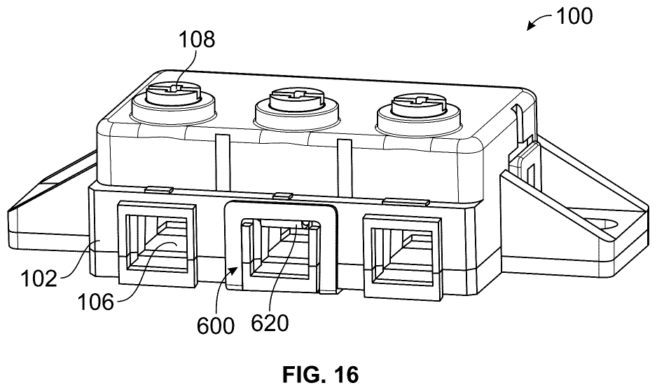

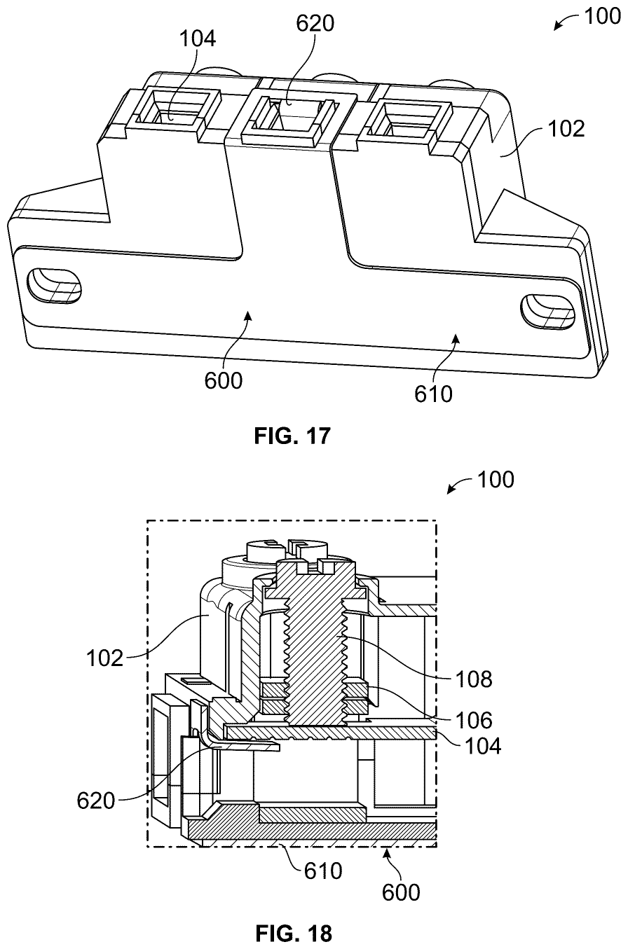

FIG. 16 is a top perspective view of the power input terminal block 100 in accordance with an exemplary embodiment. FIG. 17 is a bottom perspective view of the power input terminal block 100 in accordance with an exemplary embodiment. FIG. 18 is a cross-sectional view of the power input terminal block 100 coupled to the electrical device 50 in accordance with an exemplary embodiment. The power input terminal block 100 includes the housing 102, terminals 104, clamp contacts 106, release elements 108, and a ground strap 600.

The ground strap 600 is a conductive element. For example, the ground strap 600 is a metal ground strap. The ground strap 600 may be a stamped and formed ground strap. The ground strap 600 is coupled to the housing 102. The ground strap 600 includes a connecting end 610 configured to be electrically connected to a grounded portion of the fixture 56 to electrically ground the ground strap 600. The ground strap 600 includes a mating end 620 extending into the housing 102 to electrically connect with one of the clamp contacts 106 and/or one of the terminals 104. The ground strap 600 may be electrically connected to the corresponding supply wire 20 (for example, ground wire) when located in the power input terminal block 100.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A power input terminal block comprising:
a housing including terminal channels with separating walls between the terminal channels;
terminals received in the terminal channels, each terminal including a main body extending between a wire terminating end and a blade terminating end, the wire terminating end having a separable wire interface configured to be electrically connected to a supply wire, the blade terminating end having a separable blade interface configured to be electrically connected to a blade terminal;
clamp contacts received in the terminal channels, each clamp contact having a clamp beam configured to be electrically connected to the corresponding supply wire, wherein a poke-in window is defined between the clamp beam and the wire terminating end of the terminal configured to receive the supply wire to capture the supply wire between the clamp beam and the wire terminating end; and
release elements coupled to the housing, each release element operably coupled to the corresponding clamp contact to move the clamp beam between an extended position and a clamping position to allow loading and removal of the supply wire from the poke-in window.

2. The power input terminal block of claim 1, wherein the terminal includes a spring beam at the blade terminating end configured be coupled to the blade terminal.

3. The power input terminal block of claim 1, wherein the terminal includes a pair of spring beams at the blade terminating end defining a receptacle configured to receive the blade terminal to engage opposite sides of the blade terminal.

4. The power input terminal block of claim 1, wherein the terminal includes a plate at the wire terminating end having a mating pad defining the separable wire interface.

5. The power input terminal block of claim 1, wherein the clamp beam is positioned in the terminal channel spaced apart from the wire terminating end, the release element being actuated to change a spacing between the clamp beam and the wire terminating end.

6. The power input terminal block of claim 1, wherein the housing includes poke-in wire openings configured to receive the supply wires, the housing including blade slots configured to receive ends of the blade terminals, the wire terminating ends aligned with the poke-in wire openings, the blade terminating ends aligned with the blade slots.

7. The power input terminal block of claim 6, wherein the housing includes a top, a bottom, a front, and a rear, the bottom configured to be mounted to a fixture holding the blade terminals, the blade slots located at the bottom to receive the blade terminals.

8. The power input terminal block of claim 6, wherein the housing includes a top, a bottom, a front, and a rear, the bottom configured to be mounted to a fixture holding the blade terminals, the blade slots located at the rear to receive the blade terminals.

9. The power input terminal block of claim 1, further comprising a ground strap coupled to the housing, the ground strap including a connecting end configured to be electrically connected to a grounded portion of the fixture to electrically ground the ground strap.

10. The power input terminal block of claim 9, wherein the ground strap includes a mating end extending into the housing to electrically connect with one of the clamp contacts and/or one of the terminals.

11. The power input terminal block of claim 1, wherein the clamp contact is movable in the terminal channel to open and close the poke in window.

12. The power input terminal block of claim 11, wherein the clamp contact is slidable in a linear direction in the terminal channel.

13. The power input terminal block of claim 11, wherein the clamp contact is rotatable in the terminal channel.

14. The power input terminal block of claim 1, wherein the release element includes a threaded element threadably coupled to the clamp contact to move the clamp contact.

15. The power input terminal block of claim 1, wherein the release element is a release lever pivotably coupled to the housing, the release lever including a releasing surface operably coupled to the clamp contact to move the clamp beam.

16. A power input terminal block comprising:
a housing including terminal channels with separating walls between the terminal channels, the housing including poke-in wire openings configured to receive supply wires, the housing including blade slots configured to receive ends of blade terminals;
terminals received in the terminal channels, each terminal including a main body extending between a wire terminating end and a blade terminating end, the wire terminating end aligned with the corresponding poke-in wire opening and having a separable wire interface configured to be electrically connected to the supply wire received in the poke-in wire opening, the blade terminating end aligned with the blade slot and having a separable blade interface configured to be electrically connected to the blade terminal received in the blade slot;
clamp contacts received in the terminal channels, each clamp contact having a clamp beam aligned with the poke-in wire opening configured to be electrically connected to the corresponding supply wire received in the poke-in wire opening, wherein a poke-in window is defined between the clamp beam and the wire terminating end of the terminal configured to receive the supply wire to capture the supply wire between the clamp beam and the wire terminating end; and
release elements coupled to the housing, each release element operably coupled to the corresponding clamp contact to move the clamp beam between an extended position and a clamping position to allow loading and removal of the supply wire from the poke-in window.

17. The power input terminal block of claim 16, wherein the terminal includes a pair of spring beams at the blade terminating end defining a receptacle configured to receive the blade terminal to engage opposite sides of the blade terminal.

18. The power input terminal block of claim 16, wherein the clamp beam is positioned in the terminal channel spaced apart from the wire terminating end, the release element being actuated to change a spacing between the clamp beam and the wire terminating end.

19. A power input terminal block comprising:
a housing including terminal channels with separating walls between the terminal channels, the housing including a mounting end configured to be mounted to a fixture;
terminals received in the terminal channels, each terminal including a main body extending between a wire terminating end and a blade terminating end, the wire terminating end having a separable wire interface configured to be electrically connected to a supply wire, the blade terminating end having a separable blade interface configured to be electrically connected to a blade terminal;
clamp contacts received in the terminal channels, each clamp contact having a clamp beam configured to be electrically connected to the corresponding supply wire, wherein a poke-in window is defined between the clamp beam and the wire terminating end of the terminal configured to receive the supply wire to capture the supply wire between the clamp beam and the wire terminating end;
release elements coupled to the housing, each release element operably coupled to the corresponding clamp contact to move the clamp beam between an extended position and a clamping position to allow loading and removal of the supply wire from the poke-in window; and
a ground strap coupled to the housing, the ground strap including a connecting end configured to be electrically connected to a grounded portion of the fixture to electrically ground the ground strap.

20. The power input terminal block of claim 19, wherein the ground strap includes a mating end extending into the housing to electrically connect with one of the clamp contacts and/or one of the terminals.
